(19) United States
(12) Patent Application Publication
(10) Pub. No.: US 2014/0067747 A1
(43) Pub. Date: Mar. 6, 2014

(54) OBJECT BASED METHOD TO EVALUATE RULES

(71) Applicants: Yaowu Liu, Henrico, VA (US); Paul G. McLaughlin, Essex Junction, VT (US); Alice M. Michalak, Williston, VT (US)

(72) Inventors: Yaowu Liu, Henrico, VA (US); Paul G. McLaughlin, Essex Junction, VT (US); Alice M. Michalak, Williston, VT (US)

(73) Assignee: INTERNATIONAL BUSINESS MACHINES CORPORATION, Armonk, NY (US)

(21) Appl. No.: 13/602,432

(22) Filed: Sep. 4, 2012

(51) Int. Cl. G06N 5/02

(52) U.S. Cl. 706/47

(57) ABSTRACT

Aspects of the invention provide for a method of evaluating rules for validating, constructing, or configuring multi-level collections of business objects. In one embodiment, a method includes: receiving a request including a multi-level collection of business objects; processing each object in the collection of business objects by determining whether the object satisfies at least one rule condition and a relationship between the object and at least one other object; executing at least one rule behavior based on satisfying the at least one rule condition; and returning a response based on the processing and the executing.

### BACKGROUND OF THE INVENTION

The subject matter disclosed herein relates generally to business rules. More specifically, the disclosure provided herein relates to methods for evaluating rules for validating, constructing, or configuring collections of business objects.

Many business activities need to create valid collections of objects, but have relied on value-based rules engines to create these collections. Such rule engines are optimized for evaluating criteria based on attribute values of the information set. An example of such a rule engine is a conventional spam filter, where the engine can ask whether the e-mail subject contains certain words.

### BRIEF DESCRIPTION OF THE INVENTION

Aspects of the invention provide for a method of evaluating rules for validating, constructing, or configuring collections of business objects. In one embodiment, a method includes: receiving a request including a multi-level collection of business objects; processing each object in the collection of business objects by determining whether the object satisfies at least one rule condition and a relationship between the object and at least one other object; executing at least one rule behavior based on satisfying the at least one rule condition; and returning a response based on the processing and the executing.

A first aspect of the invention provides a computer-implemented method of evaluating rules for validating, constructing, or configuring collections of business objects, the method comprising: receiving a request including a multi-level collection of business objects; processing each object in the collection of business objects by determining whether the object satisfies at least one rule condition and a relationship between the object and at least one other object; executing at least one rule behavior based on satisfying the at least one rule condition; and returning a response based on the processing and the executing.

A second aspect of the invention provides a computer program comprising program code embodied in at least one computer-readable medium, which when executed, enables a computer system to implement a method of evaluating rules for validating, constructing, or configuring collections of business objects, the method comprising: receiving a request including a multi-level collection of business objects; processing each object in the collection of business objects by determining whether the object satisfies at least one rule condition and a relationship between the object and at least one other object; executing at least one rule behavior based on satisfying the at least one rule condition; and returning a response based on the processing and the executing.

A third aspect of the invention provides a computer system for evaluating rules for validating, constructing, or configuring collections of business objects, the computer system comprising: at least one computing device configured to evaluate rules for validating, constructing, or configuring collections of business objects by performing a method including: receiving a request including a multi-level collection of business objects; processing each object in the collection of business objects by determining whether the object satisfies at least one rule condition and a relationship between the object and at least one other object; executing at least one rule behavior based on satisfying the at least one rule condition; and returning a response based on the processing and the executing.

### BRIEF DESCRIPTION OF THE DRAWINGS

These and other features of this invention will be more readily understood from the following detailed description of the various aspects of the invention taken in conjunction with the accompanying drawings that depict various embodiments of the invention, in which:

FIG. 1 shows an illustrative environment according to embodiments of the invention.

FIG. 2 shows a system according to embodiments of the invention.

FIG. 3 shows a flow diagram of a method according to embodiments of the invention.

FIG. 4 shows a block diagram of an exemplary of a request/response object model according to embodiments of the invention.

FIG. 5 shows a block diagram of an exemplary rule definition in the rule database according to embodiments of the invention.

It is noted that the drawings of the invention are not to scale. The drawings are intended to depict only typical aspects of the invention, and therefore should not be considered as limiting the scope of the invention. In the drawings, like numbering represents like elements between the drawings.

### DETAILED DESCRIPTION OF THE INVENTION

As mentioned above, the subject matter disclosed herein relates generally to business rules. More specifically, the disclosure provided herein relates to methods for evaluating rules for validating, constructing, or configuring collections of business objects.

Many business activities need to create valid collections of objects, but have relied on value-based rules engines to create these collections. Such rule engines are optimized for evaluating criteria based on attribute values of the information set. A simple example of such a rule engine is a conventional spam filter, where the engine can ask whether the e-mail subject contains certain words. A more complex example is a form routing system, where the engine can direct data through an office workflow based upon the request type or whether the customer's credit has been approved.

Aspects of the invention provide for a method of evaluating rules for validating, constructing, or configuring collections of business objects. In one embodiment, a method includes: receiving a request including a multi-level collection of business objects; processing each object in the collection of business objects by determining whether the object satisfies at least one rule condition and a relationship between the object and at least one other object; executing at least one rule behavior based on satisfying the at least one rule condition plus any remaining rule conditions of the rule; and returning a response based on the processing and the executing. This method is an object-rule evaluation; rather, than an attribute value evaluation, so that real-time performance is improved. Only rules that are associated with the object in question are examined during the evaluation. Further, multi-level collections that account for relationships between objects are easily evaluated.

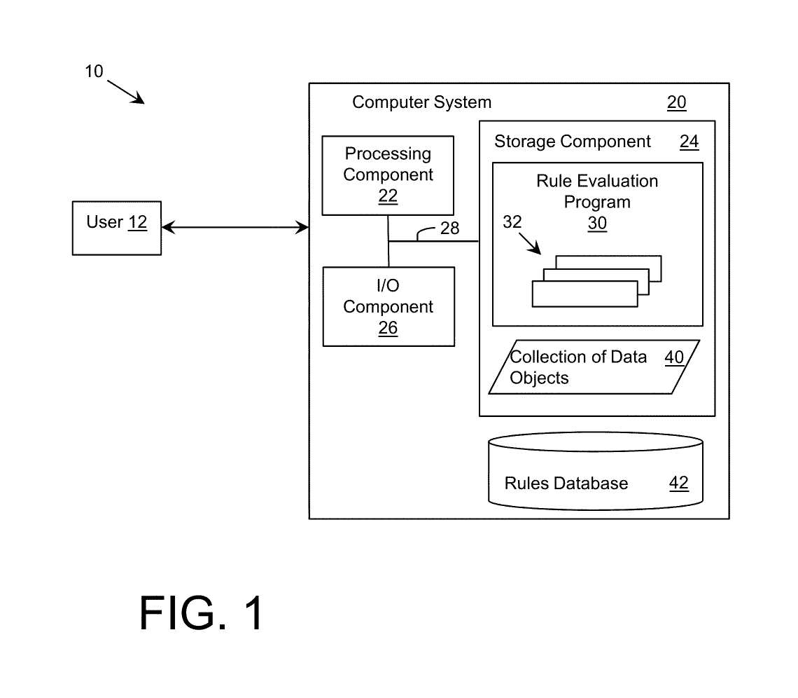

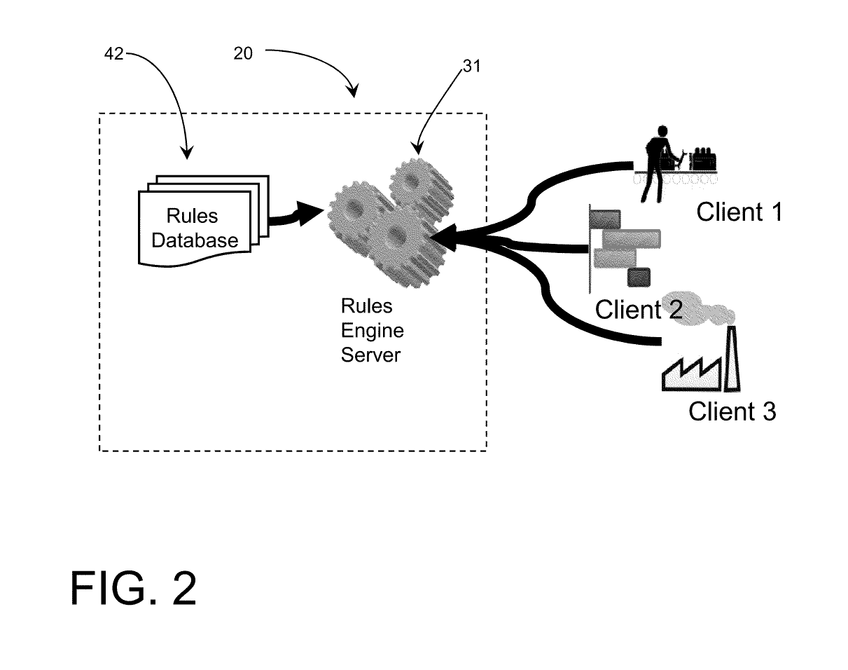

Turning now to FIG. 1, an illustrative environment 10 for evaluating rules for validating, constructing, or configuring collections of business objects 40 according to embodiments of the invention is shown. To this extent, environment 10 includes a computer system 20 that can perform a process described herein in order to evaluate rules for a collection of business objects 40. In particular, computer system 20 is shown including a Rule Evaluation program 30, which makes computer system 20 operable to evaluate a collection of business objects 40 by performing the process described below with respect to FIGS. 2-4.

Computer system 20 is shown including a processing component 22 (e.g., one or more processors), a storage component 24 (e.g., a storage hierarchy), an input/output (I/O) component 26 (e.g., one or more I/O interfaces and/or devices), and a communications pathway 28. In general, processing component 22 executes program code, such as Rule Evaluation program 30, which is at least partially fixed in storage component 24. While executing program code, processing component 22 can process data, which can result in reading and/or writing transformed data from/to storage component 24 and/or I/O component 26 for further processing. Pathway 28 provides a communications link between each of the components in computer system 20. I/O component 26 can comprise one or more human I/O devices, which enable a human user 12 to interact with computer system 20 and/or one or more communications devices to enable a system user 12 to communicate with computer system 20 using any type of communications link. To this extent, Rule Evaluation program 30 can manage a set of interfaces (e.g., graphical user interface(s), application program interface, and/or the like) that enable human and/or system users 12 to interact with Rule Evaluation program 30. Further, Rule Evaluation program 30 can manage (e.g., store, retrieve, create, manipulate, organize, present, etc.) the data, such as a collection of business objects 40 (received by user 12), using any solution.

In any event, computer system 20 can comprise one or more general purpose computing articles of manufacture (e.g., computing devices) capable of executing program code, such as Rule Evaluation program 30, installed thereon. As used herein, it is understood that “program code” means any collection of instructions, in any language, code or notation, that cause a computing device having an information processing capability to perform a particular action either directly or after any combination of the following: (a) conversion to another language, code or notation; (b) reproduction in a different material form; and/or (c) decompression. To this extent, Rule Evaluation program 30 can be embodied as any combination of system software and/or application software.

Further, Rule Evaluation program 30 can be implemented using a set of modules 32. In this case, a module 32 can enable computer system 20 to perform a set of tasks used by Rule Evaluation program 30, and can be separately developed and/or implemented apart from other portions of Rule Evaluation program 30. As used herein, the term “component” means any configuration of hardware, with or without software, which implements the functionality described in conjunction therewith using any solution, while the term “module” means program code that enables a computer system 20 to implement the actions described in conjunction therewith using any solution. When fixed in a storage component 24 of a computer system 20 that includes a processing component 22, a module is a substantial portion of a component that implements the actions. Regardless, it is understood that two or more components, modules, and/or systems may share some/all of their respective hardware and/or software. Further, it is understood that some of the functionality discussed herein may not be implemented or additional functionality may be included as part of computer system 20.

When computer system 20 comprises multiple computing devices, each computing device can have only a portion of Rule Evaluation program 30 fixed thereon (e.g., one or more modules 32). However, it is understood that computer system 20 and Rule Evaluation program 30 are only representative of various possible equivalent computer systems that may perform a process described herein. To this extent, in other embodiments, the functionality provided by computer system 20 and Rule Evaluation program 30 can be at least partially implemented by one or more computing devices that include any combination of general and/or specific purpose hardware with or without program code. In each embodiment, the hardware and program code, if included, can be created using standard engineering and programming techniques, respectively.

Regardless, when computer system 20 includes multiple computing devices, the computing devices can communicate over any type of communications link. Further, while performing a process described herein, computer system 20 can communicate with one or more other computer systems using any type of communications link. In either case, the communications link can comprise any combination of various types of optical fiber, wired, and/or wireless links; comprise any combination of one or more types of networks; and/or utilize any combination of various types of transmission techniques and protocols.

As discussed herein, Rule Evaluation program 30 enables computer system 20 to evaluate rules for a collection of business objects 40 that are received in a request from user 12. To this extent, computer system 20 may perform the method according to aspects of the invention, as discussed herein with respect to FIGS. 2-4.

Turning now to FIG. 2, a system according to embodiments of the invention is shown. Clients 1, 2, 3 (i.e., user 12 in FIG. 1) send requests to a rules engine server 31, which is a part of Rule evaluation program 30 (and computer system 20). Rules engine server 31 communicates with rules database 42 in order to evaluate rules in the rules database 42 to validate, construct, or configure a collection of objects 40 (FIG. 1) in the request sent by clients 1, 2, 3. To improve performance, it would be natural to implement the invention with a data cache to minimize database queries. Although only three clients 1, 2, 3 are shown, it is understood that many clients may be in communication with rules engine server 31. The clients 1, 2, 3 may be be, for example, multiple instances of the same kind of application (e.g., applications that a planning department uses to derive sourcing decisions). Clients 1, 2, 3 may also be instances of different types of applications (e.g., an enterprise environment that includes a planning application, a design checking application, and a manufacturing floor control application). Thus, clients 1, 2, 3 are the software components that various users 12 go through (directly or indirectly) to interact with the rules engine.

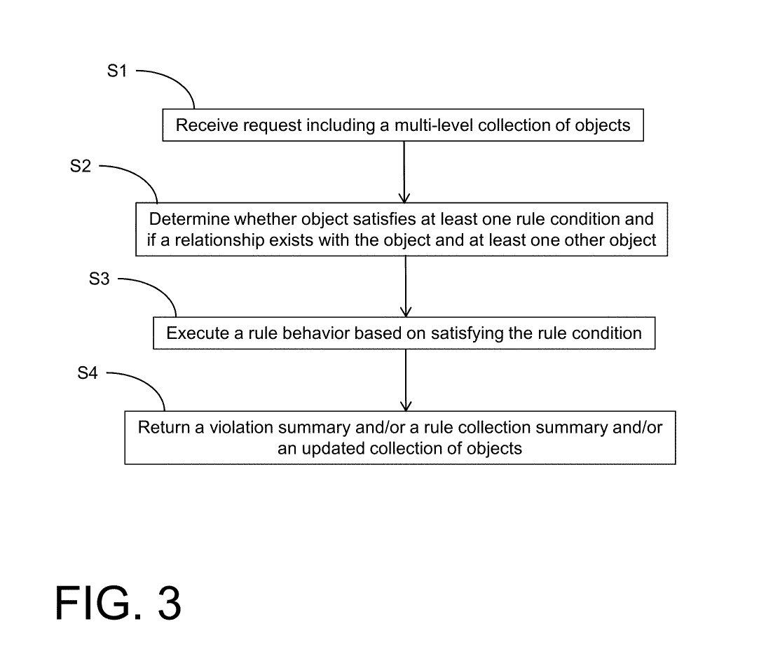

Turning now to FIG. 3, a flow diagram of a method according to embodiments of the invention is shown. The flow diagram will be described herein, with respect to FIGS. 1-2 and 4-5.

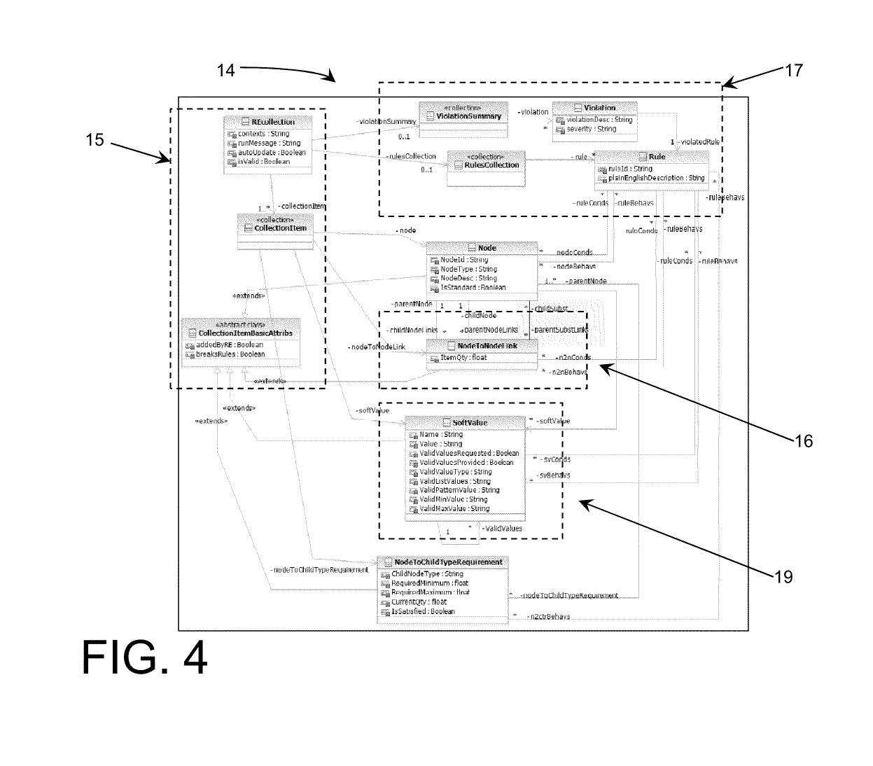

At S1, a request is received by rules engine server 31 from a client 1, 2, 3. The request includes a multi-level collection of objects. At S2, each object in the collection of business objects is processed. That is, the rules engine server 42 determines whether each object satisfies at least one rule condition and also whether there is a relationship between the object and at least one other object. For example, a relationship may require that the at least one other object satisfies another rule condition. For example, rules engine server 42 may determine whether at type for the object satisfies the at least one rule condition. Alternatively, rules engine server 42 may determine whether an attribute value 19 (FIG. 4) of the object satisfies the at least one rule condition. Further, rules engine server 42 may determine whether a component of the object satisfies the at least one rule condition. It is understood that there may be more than one rule condition associated with a rule.

If the at least one rule condition is satisfied, at S3, the rule is examined for additional rule conditions. If the at least one rule condition plus any additional rule conditions are satisfied, then one or more rule behaviors associated with the rule are executed. In this way, only rules that are associated with the object are examined. Therefore, rules that would not be executed with the particular object would be ignored, with ensuring performance benefits. At S4, a violation summary and/or a rule collection summary and/or an updated collection of objects is returned in a response.

Turning now to FIG. 4, a block diagram of an exemplary of a request/response object model 14 according to embodiments of the invention is shown. In a request, as mentioned above, a multi-level collection of objects 15 are sent. There may be relationships between objects, which are described in the NodeToNodeLink 16. In the response that is returned, a violation summary and rule collection summary 17 may be provided. The response may also include the object collection itself, and that collection might have become updated during the course of executing rule behaviors.

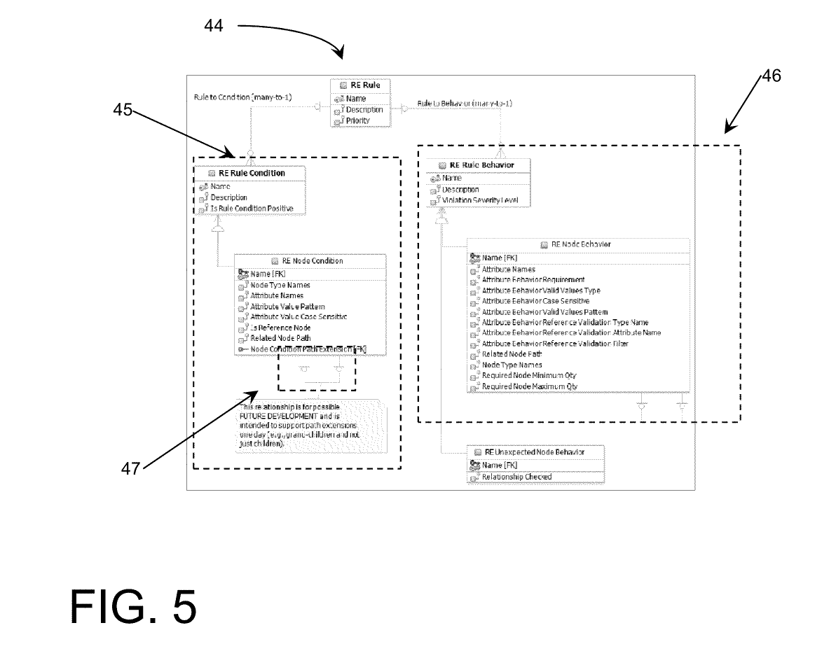

Turning now to FIG. 5, a block diagram of an exemplary rule definition in the rule database 42 according to embodiments of the invention is shown. Rule 44 includes at least one rule condition 45. Although only one rule condition 45 is shown, it is understood that rule 44 may require more than one rule condition 45. Rule 44 also includes one or more rule behaviors 46 that are executed if all rule conditions 45 are satisfied.

In the embodiments discussed above, the rules engine server 31 of Rule evaluation program 30 evaluates from node to rule in order to narrow the evaluation to only rules that are associated with the objects in a request. In this way, multi-level collection of objects may be evaluated efficiently.

An example of rules engine server 31 includes a checker for a bill of materials (BOMs). A custom client is created that knows how to assemble a request for the rules engine 31. The request includes a multi-level collection of business objects as well as their component relationships (i.e., the bills of materials). The collection can have many levels of hierarchy. The client submits its collection to the rules engine 31.

The rules engine 31 checks the collection against business rules and formulates a response. In the semiconductor industry, some example rules might cover component requirements for modules (must have at least one chip in its assembly BOM), requirements for chips (must have valid technology relationships), and so on for wafers, packaging, and the like. Besides checking for minimum requirements, additional rules might check for invalid components. For example, trying to put a module on the chip BOM when the module is supposed to be the other way around, or mutually exclusive components (e.g., two engineering specifications that are incompatible). In each of these cases, the rules engine 31 is detecting conditions related to the structure and executing behaviors for the rules that are satisfied. In the case of the mutually exclusive components, the condition might be “when module part contains engineering spec A” and the behavior might be “make sure engineering spec B isn't also on the BOM”. As the rules engine identifies behaviors that get violated, it adds them to the response data structure (which itself it another multi-level collection).

Finally, once the collection has been checked, the rules engine 31 returns the response data structure to the client. The client interprets the response and renders a suitable report to the user.

Another example of a rules engine server 31 may be an automatic BOM builder. In this example, a custom client is created that knows how to assemble a multi-level collection of requirements. The requirements hierarchy would cover various major systems in the engagement (e.g., to build a plane—wings, nose, tail) and also their sub-systems and sub-sub-systems (e.g., engines, flaps, and slats for the wing, and so on). The client submits its collection to the rules engine 31.

The rules engine 31 formulates a response that renders the multi-level BOM for the product. Rules would dictate structures to assemble (e.g., “include a part in the BOM for the special fitting” or not) and would further dictate specific choices where applicable (e.g., “since the request asked for the enhanced collision avoidance system, be sure to select parts 12345 and 67890 which are the necessary radar options). Up and down the requirements hierarchy for each of these cases, the rules engine 31 is detecting conditions related to the requirements and executing behaviors for the rules that are satisfied. Conditions do not have to be solely based on requirements since parts can demand other parts. Finally, violations can be detected and reported (e.g., “cannot require the stealth package if hot pink paint job is requested”).

In the end, the rules engine 31 responds with a data structure that represents a multi-level BOM structure as well as possible violation information. The client interprets the response, takes action in case of violation, and implements the BOM structure into the part management database.

Another example of a rules engine server 31 is a manufacturing routing generator and/or a sourcing planner. In this example, a custom client knows how to assemble a multi-level collection of planning requirements. These requirements include the appropriate plannable BOM components as well as relevant product requirements. The collection is expected to be multi-level, and this depth is valuable to the business. The client submits its collection to the rules engine 31.

The rules engine 31 formulates a response that renders a list of manufacturing steps to follow (routing generator) or a path through multiple manufacturing locations and vendors (sourcing planner). Both cases can be viewed as streams flowing in parallel, joining, and splitting as needed by the enterprise. Rules would dictate which steps and locations must be included depending on the BOM components and other requirements provided in the request. For example, if a new cell phone product is required to be a touch screen, then the appropriate touch screen vendor must be included in the sourcing. If a product has to meet import requirements in Southeast Asia, then be sure to only select vendors from that geography. And within an individual manufacturing line, add the appropriate steps needed to construct, assemble, and test as appropriate. In each of these cases, the rules engine 31 is detecting conditions related to the BOM components and product requirements and is executing behaviors for the rules that are satisfied. As before, violations can be detected and reported.

Finally, the rules engine responds with the data structures that represent the multi-level sourcing and manufacturing plans as well as possible violation information. The client interprets the response, takes appropriate actions, and implements the plans into the enterprise resource planning (ERP) systems and manufacturing control systems.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A computer-implemented method of evaluating rules for validating, constructing, or configuring collections of business objects, the method comprising:
receiving a request including a multi-level collection of business objects;
processing each object in the collection of business objects by determining whether the object satisfies at least one rule condition and a relationship between the object and at least one other object;
executing at least one rule behavior based on satisfying the at least one rule condition; and
returning a response based on the processing and the executing.

2. The computer-implemented method of claim 1, wherein processing further comprises:
determining whether one of: a type, a component, or an attribute value for the object satisfies the at least one rule condition.

3. The computer-implemented method of claim 1, further comprising, in response to satisfying the at least one rule condition:
examining a rule associated with the at least one rule condition; and
determining if other rule conditions are associated with the rule.

4. The computer-implemented method of claim 1, wherein the response includes a violation summary for the multi-level collection of objects.

5. The computer-implemented method of claim 1, wherein the response includes a rule collection summary for the multi-level collection of objects.

6. The computer-implemented method of claim 1, wherein the response includes an updated collection of business objects.

7. The computer-implemented method of claim 1, wherein the at least one condition is associated with a related object satisfying another condition.

8. A computer program comprising program code embodied in at least one computer-readable medium, which when executed, enables a computer system to implement a method of evaluating rules for validating, constructing, or configuring collections of business objects, the method comprising:
receiving a request including a multi-level collection of business objects;
processing each object in the collection of business objects by determining whether the object satisfies at least one rule condition and a relationship between the object and at least one other object;
executing at least one rule behavior based on satisfying the at least one rule condition; and
returning a response based on the processing and the executing.

9. The computer program of claim 8, wherein processing further comprises:
determining whether one of: a type, a component, or an attribute value for the object satisfies the at least one rule condition.

10. The computer program of claim 8, further comprising, in response to satisfying the at least one rule condition:
examining a rule associated with the at least one rule condition; and
determining if other rule conditions are associated with the rule.

11. The computer program of claim 8, wherein the response includes a violation summary for the multi-level collection of objects.

12. The computer program of claim 8, wherein the response includes a rule collection summary for the multi-level collection of objects.

13. The computer program of claim 8, wherein the response includes an updated multi-level collection of objects.

14. The computer program of claim 8, wherein the at least one condition is associated with a related object satisfying another condition.

15. A computer system for evaluating rules for validating, constructing, or configuring collections of business objects, the computer system comprising:
at least one computing device configured to evaluate rules for validating, constructing, or configuring collections of business objects by performing a method including:
receiving a request including a multi-level collection of business objects;
processing each object in the collection of business objects by determining whether the object satisfies at least one rule condition and a relationship between the object and at least one other object;
executing at least one rule behavior based on satisfying the at least one rule condition; and
returning a response based on the processing and the executing.

16. The computer system of claim 15, wherein processing further comprises:
determining whether one of: a type, a component, or an attribute value for the object satisfies the at least one rule condition.

17. The computer system of claim 15, further comprising, in response to satisfying the at least one rule condition:
examining a rule associated with the at least one rule condition; and
determining if other rule conditions are associated with the rule.

18. The computer system of claim 15, wherein the response includes a violation summary for the multi-level collection of objects.

19. The computer system of claim 15, wherein the response includes a rule collection summary for the multi-level collection of objects.

20. The computer system of claim 15, wherein the response includes an updated multi-level collection of objects.
